(19) United States
(12) Patent Application Publication
(10) Pub. No.: US 2019/0133147 A1
(43) Pub. Date: May 9, 2019

(54) CONFECTIONERY PRODUCT

(71) Applicant: TSUBO SOLUTIONS PTY LTD, Subiaco, Western Australia (AU)

(72) Inventor: Nicola Ranelli, Perth (AU)

(73) Assignee: TSUBO SOLUTIONS PTY LTD, Subiaco, West Australia (AU)

(21) Appl. No.: 16/300,278

(22) PCT Filed: Jul. 14, 2016
(86) PCT No.: PCT/AU2016/050614

§ 371 Date: Nov. 9, 2018

(30) Foreign Application Priority Data
May 11, 2016 (AU) AU 2016901759
Jul. 1, 2016 (AU) AU 2016902556

(51) Int. Cl. A23G 3/54; A23G 3/56; A23G 3/36; A23G 3/48; A23G 3/44; A23G 3/42; A23G 4/20

(52) U.S. Cl. CPC A23G 3/54; A23G 3/56; A23G 3/368; A23G 3/48; A23G 3/44; A23G 2200/14; A23G 4/20; A23G 2220/14; A23G 2200/04; A23G 2200/10; A23G 3/42

(57) ABSTRACT

A confectionery product for consumption before, during and/or after physical exercise is described. The confectionery product comprises a hard candy outer portion and a core of chewy candy encapsulated in the hard candy outer portion. The hard candy outer portion comprises a first nutritional supplement formulated for consumption before physical exercise. The core of chewy candy comprises a second nutritional supplement formulated for consumption during and/or after physical exercise. In use, the hard candy outer portion is consumed before the core so as to sequentially deliver the first and second nutritional supplements to the consumer. A method of sequentially delivering nutritional supplements respectively formulated to be consumed before, during and/or after physical exercise, and a method of preparing a confectionery product for consumption before, during and/or after physical exercise are also described.

### TECHNICAL FIELD

The present disclosure generally relates to a confectionery product for consumption before, during and/or after physical exercise.

### BACKGROUND

Nutritional supplements are becoming increasingly popular, particularly for those who undertake physical exercise on a frequent or intensive basis. Pre-workout supplements, for example, are formulated to provide increased energy, concentration and endurance. Intra- and post-workout recovery supplements, on the other hand, are formulated and consumed to promote muscle repair, replenish energy stores and reduce muscle breakdown after intensive physical exercise.

These supplements are typically available in dry powdered form for consumption when mixed with liquid in the form of ‘shakes’. The supplement powders are packaged and purchased in large quantities (e.g. 1 kg) and it is not uncommon for gym participants to be accompanied by several bulky plastic jars of packaged supplement powders respectively formulated for consumption before, during and after fitness workouts.

There is thus a need to develop a compact, convenient and consumable form of nutritional supplement which reduces the need to carry and consume several different types of nutritional supplements immediately before, during and after physical exercise.

### SUMMARY

The present disclosure provides a confectionery product for consumption before, during and/or after physical exercise.

The confectionery product for consumption before, during and/or after physical exercise comprises:
a) a hard candy outer portion comprising a first nutritional supplement formulated for consumption before physical exercise; and
b) a core of chewy candy encapsulated in the hard candy outer portion, said core comprising a second nutritional supplement formulated for consumption during and/or after physical exercise, wherein, in use, the hard candy outer portion is consumed before said core so as to sequentially deliver the first and second nutritional supplements to the consumer.

In one particular embodiment, said confectionery product further comprises an edible stick having a first end extending into the core of chewy candy, said edible stick comprising a third nutritional supplement formulated for consumption after physical exercise. In one form the third nutritional supplement comprises an electrolyte composition.

The present disclosure also provides a method of sequentially delivering nutritional supplements respectively formulated to be consumed before, during and/or after physical exercise.

Said method comprises:

providing a confectionery product comprising:
a) a hard candy outer portion comprising a first nutritional supplement formulated for consumption before physical exercise; and
b) a core of chewy candy encapsulated in the hard candy outer portion, said core comprising a second nutritional supplement formulated for consumption during and/or after physical exercise;
   wherein the first nutritional supplement is consumed by keeping said confectionery product in the oral cavity for a period of time sufficient to dissolve the hard candy outer portion, thereby liberating said core, and
   the second nutritional supplement is subsequently consumed by masticating said liberated core in the oral cavity for a period of time sufficient to consume the second nutritional supplement.

In one embodiment, the hard candy outer portion is consumed prior to undertaking physical exercise and said liberated core may be subsequently consumed during and/or after undertaking physical exercise.

In certain embodiments, wherein the confectionery product further comprises an edible stick having a first end extending into the core of chewy candy, said edible stick comprising a third nutritional supplement, the stick may be consumed after the hard candy outer portion and the liberated core have been consumed.

The present disclosure further provides a method of preparing a confectionery product for consumption before, during and/or after physical exercise, wherein said method comprises:
providing a molten hard candy precursor comprising a first nutritional supplement formulated for consumption before physical exercise
forming a core of chewy candy comprising a second nutritional supplement formulated for consumption during and/or after physical exercise,
encapsulating said core in said molten hard candy precursor and cooling said molten hard candy precursor to produce a hard candy outer portion.

Said method may further comprise the step of encapsulating a first end of an edible stick comprising a third nutritional supplement in the core of chewy candy prior to encapsulating said core in said molten hard candy precursor.

### BRIEF DESCRIPTION OF DRAWINGS

Preferred embodiments of the present invention will now be further described and illustrated, by way of example only, with reference to the accompanying drawing in which:

FIG. 1 provides a schematic representation of a confectionery product according to one embodiment described herein; and,

FIG. 2 provides a schematic representation of a confectionery product according to another embodiment described herein.

### DETAILED DESCRIPTION

The present invention is described in the following various non-limiting embodiments, which relate to a confectionery product for enhancing physical performance.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be clearly understood that, although a number of prior art publications are referred to herein, this reference does not constitute an admission that any of these documents forms part of the common general knowledge in the art, in Australia or in any other country.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Specific Terms

The term ‘confectionery product’ as used herein refers to a product that is primarily made of sugar or a sugar-like material such as corn syrup and sugar alcohols such as sorbitol and mannitol. Confectionery products may include exemplary substances such as lozenges, tablets, chewy candy, hard candy, jellygum candy and so forth. In general, the sugar or sugar-like material will comprise from about 5 to about 99% and preferably 20 to 95% by weight of the confectionery product.

The term ‘physical exercise’ as used herein is a reference to any bodily activity that is planned, structured, and repetitive for the purposes of enhancing or maintaining physical fitness and overall health and wellness. The bodily activity may be aerobic, anaerobic or cardiovascular exercise which is geared to provide a sufficient cardiovascular overload to stimulate increases in cardiac output. Exemplary forms of cardiovascular exercise include, but are not limited to, running, jumping, skipping, boxing, swimming, cycling, skiing. Cardiovascular exercise may be performed at high intensity for relatively short periods or at low intensity over prolonged periods to enhance physical endurance. Alternatively, the bodily activity may be anaerobic, in particular weight bearing exercise such as weight lifting.

The term ‘nutritional supplement’ as used herein refers to a substance intended for ingestion that contains one or more dietary ingredients intended to add further nutritional value to supplement the consumer's diet. The dietary ingredient may be one, or any combination, of the following substances: a vitamin, a mineral, a herb or botanical, an amino acid, a phytochemical, a dietary substance for use by people to supplement the diet by increasing the total dietary intake, a concentrate, metabolite, constituent or extract.

The term ‘consumer’ as used herein refers to a person who orally ingests the confectionery product. Similarly, the term ‘consumption’ as used herein refers to the act of orally ingesting the confectionery product. The act of orally ingesting the confectionery product may be achieved by first dissolving the hard candy outer portion of the confectionery product in the person's oral cavity with the person's saliva (i.e. sucking) and, when the hard candy outer portion is consumed thereby releasing the core of chewy candy formerly encapsulated in the hard candy outer portion, then masticating (i.e. chewing) the core of chewy candy in the person's oral cavity.

### Confectionery Product

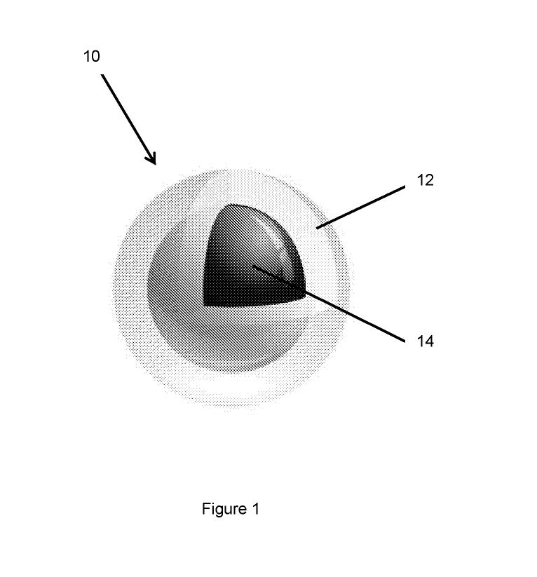

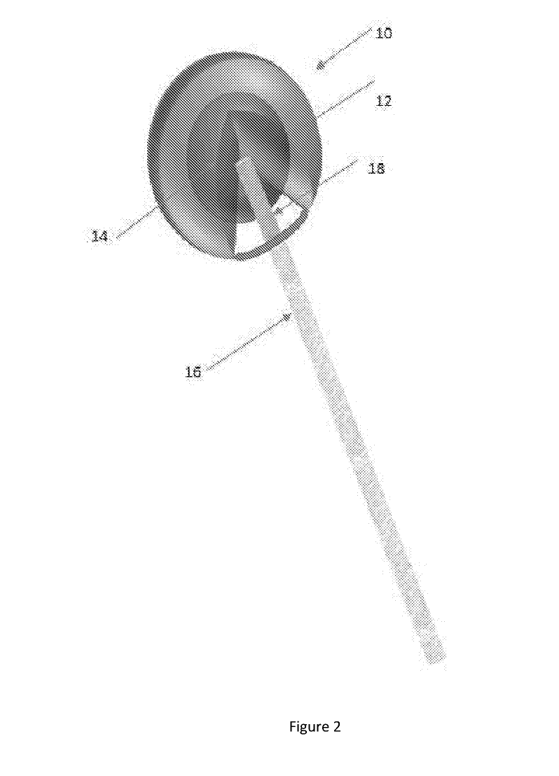

Referring to the figures wherein like reference numerals refer to like parts throughout, FIG. 1 shows one embodiment of a confectionery product 10 for consumption before, during and/or after physical exercise and FIG. 2 shows an alternative embodiment of a confectionery product 10′ for consumption before, during and after physical exercise.

The confectionery product 10 shown in FIG. 1 includes a hard candy outer portion 12 and a core 14 of chewy candy encapsulated in the hard candy outer portion 12.

The confectionery product 10′ shown in FIG. 2 includes a hard candy portion 12 and a core 14 of chewy candy encapsulated in the hard candy outer portion 12. The confectionery product 10′ also includes an edible stick 16 having a first end 18 extending into the core 14 of chewy candy.

The hard candy outer portion 12 comprises a first nutritional supplement which is formulated for consumption before physical exercise.

The core 14 of chewy candy comprises a second nutritional supplement which is formulated for consumption during and/or after physical exercise.

The edible stick 16 comprising a third nutritional supplement formulated for consumption after physical exercise.

In use, the hard candy outer portion 12 is consumed before said core 14 so as to sequentially deliver the first and second nutritional supplements to the consumer. Finally, the edible stick 16 may be consumed to deliver the third nutritional supplement.

The hard candy outer portion 12 may be processed and formulated by conventional means. In general, the hard candy outer portion 12 is prepared from a mixture of sugar and other carbohydrates that are kept in an amorphous or glassy condition. This form can be considered a solid syrup of sugars generally having from about 0.5 to about 1.5% moisture. Such materials normally contain up to about 92% corn syrup, up to about 70% sugar and from about 0.1 to about 5.0% water. The syrup component generally is prepared from corn syrups high in fructose, but may include other materials.

Alternatively, the hard candy outer portion 12 may be prepared from non-fermentable sugars such as sorbitol, mannitol, xylitol, maltitol, isomalt, erythritol and hydrogenated starch hydrosylates. A typical hydrogenated starch hydrosylate is lycasin. The hard candy outer portion 12 may contain up to about 95% sorbitol, a mixture of sorbitol and mannitol at a ratio of about 9.5 to 0.5 up to about 7.5 to 2.5 and hydrogenated corn syrup up to about 55% of the syrup component.

The hard candy outer portion 12 may be routinely prepared by conventional methods such as those involving fire cookers, vacuum cookers, and scraped-surface cookers also referred to as high speed atmospheric cookers.

The core 14 of chewy candy may be processed and formulated by conventional means. In general, the core 14 of chewy candy is prepared from a boiled sugar-corn syrup blend to which is added a frappe mixture The boiled sugar-corn syrup blend may be prepared from sugar and corn syrup blended in parts by weight ratio of about 90 to 10 to about 10 to 90. The blend is heated to above 121° C. to remove water and to form a molten mass. The frappe is generally prepared from gelatin, egg albumen, milk proteins such as casein and vegetable proteins such as soy protein, and the like which are added to a gelatin solution and rapidly mixed at ambient temperature to form an aerated sponge-like mass. The frappe is then added to the molten candy base and mixed until homogenous at temperatures between 65° C. and 121° C.

The edible stick 16 may be a compressed candy routinely prepared by conventional methods for making tablet-like candies. Alternatively, the edible stick 16 may be an extruded candy prepared by conventional methods.

Further ingredients such as flavouring agents, sweetening agents, acidulants, colorants and so forth may also be added to the hard candy outer portion 12, the core 14 of chewy candy and the edible stick 16.

The flavouring agents which may be used include flavours, such as natural, synthetic and artificial flavours, known to the person skilled in the art. Suitable flavouring agents may be selected from flavour oils and flavouring aromatics and/or oils, oleoresins and extracts derived from plants, leaves, flowers, fruits, and so forth, and combinations thereof. Exemplary flavour oils include, but are not limited to, spearmint oil, peppermint oil, citrus oils, cinnamon oil, clove oil, bay oil, anise oil, eucalyptus oil, thyme oil, sage oil, and bitter almond oil. Exemplary flavourings may include, but are not limited to, natural and synthetic fruit flavours such as vanilla, citrus including lemon, orange, lime, grapefruit, mandarin, and fruit essences including apple, pear, peach, grape, mango, mangosteen, lychee, blackcurrant, strawberry, raspberry, blueberry, cherry, plum, pineapple, apricot, fig and so forth. Exemplary flavourings may include, but are not limited to synthetic flavours such as apple crumble, biscuit, cookie dough, choc-mint, choc-honeycomb, choc hazelnut (Nutella), choc-peanut-caramel-nougat (Snickers), fresh bread, bun spice, brown sugar, caramel, butter, butter schnapps, cookies and cream, crème brule, plum pudding, vanilla custard, vanilla ice cream, condensed milk, warm milk, brandy, Cointreau, crème de menthe, Frangelico, Pina Colada, rum, whiskey, bittering, bubblegum, fruit tingle, berry burst, tutti frutti, fairy floss (cotton candy), blue fruit, honeybush, caramel pear, caramelized banana, cheesecake, Devonshire Cream, mochacino, salted caramel, roast hazelnut, peanut butter, vanilla marshmallow.

The content of flavouring agent of the hard candy outer portion 12, the core 14 of chewy candy and the edible stick 16 is from about 0.1% to about 1.0% by weight, respectively, depending on the type of flavour.

The sweetening agents which may be used include sweetening agents known to the person skilled in the art. Suitable sweetening agents may include, but are not limited to, natural sweeteners or synthetic sweeteners such as amino acid based sweeteners, dipeptide sweeteners, especially aspartame, glycerrhizin, saccharin and its salts, acesulfame salts such as acesulfame potassium, cyclamates, steviosides, talin, dihydrochalcone compounds, sucralose, stevia, waxy maize, maltodextrin, dextrose and mixtures thereof. The sweetener is generally present in the confectionery product from about 0.1% to about 99% by weight of the confectionery product.

The content of sweetening agent of the hard candy outer portion 12, the core 14 of chewy candy and the edible stick 16 is from about 1% to about 90% by weight, respectively, depending on the type of desired flavour.

The acidulants which may be used include acidulants known to the person skilled in the art. Suitable acidulants may include, but are not limited to, acetic acid, citric acid, fumaric acid, lactic acid, malic acid, tartaric acid and combinations thereof.

The content of acidulent of the hard candy outer portion 12, the core 14 of chewy candy and the edible stick 16 is from about 0.01% to about 1.0% by weight, respectively, depending on the type of desired flavour.

The colorants which may be used include colour additives, such as natural, synthetic and artificial colour additives, known to the person skilled in the art. Colour additives referred to as natural colours may be obtained from fruit, vegetable, animal and mineral sources or may be the synthetic duplicates of the naturally existing colorants. Natural colour additives may include, but are not limited to, turmeric, beta carotene, annatto, apo carotenal, paprika, beet, anthocyanins, carmine/cochineal, acid stable blue and combinations thereof. Artificial colour additives may include, but are not limited to, FD&C Yellow #5, FD&C Yellow #6, FD&C Red # 40, FD&C Blue #1, and combinations thereof.

The content of colourant of the hard candy outer portion 12, the core 14 of chewy candy and the edible stick 16 is from about 0.01% to about 0.1% by weight, respectively, depending on the type of colourant.

### Nutritional Supplements

The first nutritional supplement is different from the second nutritional supplement. The third nutritional supplement is different from the first and the second nutritional supplements.

The first nutritional supplement is formulated for consumption before physical exercise. The first nutritional supplement may comprise one or more substances that provide one or more characteristics beneficial for undertaking physical exercise including, but not limited to, increased energy, enhanced concentration or focus, improve or enhance neuron pathway signaling, increased endurance and/or stamina, reduced fatigue, increased muscle strength and/or power, increased muscle size, accelerated fat loss, efficient nutrient delivery, balanced hormone levels, improved metabolism, and so forth.

The second nutritional supplement is formulated for consumption during and/or after physical exercise. The second nutritional supplement may comprise one or more substances that provide one or more characteristics beneficial for recovering from physical exercise including, but not limited to, replenishment of electrolytes, buffering of lactic acid in the blood, accelerated fat loss, improved protein synthesis for muscle recovery, reduced inflammation, efficient nutrient delivery, balanced hormone levels, releasing hormones to enhance exercise performance, improved metabolism, and so forth.

The third nutritional supplement is formulated for consumption after physical exercise. The third nutritional supplement may comprise one or more substances that provide one or more characteristic beneficial for recovering from physical exercise including, but not limited to, replenishment of electrolytes.

The first nutritional supplement may comprise one or more substances selected from a group comprising an amino acid such as essential amino acids, non-essential amino acids and branched chain amino acids, derivatives and salts thereof; a stimulant; a vitamin; a mineral; a botanical; creatine, derivatives and salts thereof; dimethylaminoethanol, derivatives and salts thereof; and choline compounds such as L-α glycerylphosphorylcholine.

The second nutritional supplement may comprise one or more substances selected from the group comprising amino acids such as essential amino acids, non-essential amino acids and branched chain amino acids, derivatives and salts thereof; a vitamin; a mineral, in particular electrolytes; a botanical; acetyl L-carnitine, acetyl N-carnitine, derivatives and salts thereof; and pyrroloquioline quinone, derivatives and salts thereof.

The third nutritional supplement may comprise one or more substances selected from the group comprising a carbohydrate such as a sugar; a vitamin; a mineral, in particular electrolytes; and a botanical.

### Amino Acids

An essential amino acid is an amino acid that cannot be synthesised by a human , and thus must be supplied in its diet. The nine amino acids humans cannot synthesize are phenylalanine, valine, threonine, tryptophan, methionine, leucine, isoleucine, lysine and histidine. Leucine, isoleucine and valine are also known as branched chain amino acids.

The first and second nutritional supplements may comprise one or more essential amino acids or salts thereof, in particular tryptophan and/or lysine or the salts thereof. Tryptophan is a biochemical precursor for serotonin, niacin and auxin (a phytohormone). Lysine plays an important role in calcium absorption, building muscle protein, recovering from sports injuries, and the human body's production of hormones, enzymes and antibodies.

The first and second nutritional supplements may comprise non-essential amino acids including, but not limited to α-amino acids, β-amino acids, branched chain amino acids and salts thereof. A non-essential amino acid is an amino acid that can be synthesised by a human.

An 60 -amino acid is an molecule containing an amino group and a carboxylic acid group that are separated by one carbon, called the α-carbon. There are twenty standard amino acids which differ in their structure by virtue of the side chain (R group) attached to the α-carbon. The α-amino acid may be an essential amino acid or a non-essential amino acid. The first nutritional supplement may comprise one or more non-essential α-amino acids selected from a group comprising tyrosine, glutamine, arginine, aspartic acid or aspartates, citrulline, alanine, and salts thereof.

Tyrosine is a recognised precursor of neurotransmitters and consumption may increase plasma neurotransmitter levels, in particular dopamine and norepinephrine. Consumption of glutamine has been associated with protein synthesis, production of cellular energy, lipid synthesis, and regulation of acid-base balance in the kidneys.

Arginine is a precursor for synthesis of nitric oxide which may be responsible for increased blood flow. Benefits of consumption may include, but is not limited to, reduced healing time of injuries, rapid repair time of damaged tissue, decreased blood pressure and be involved with the synthesis of creatine and growth hormone.

Consumption of aspartic acid and aspartates may stimulate the production of neurotransmitters in the body.

Citrulline is a synthetic precursor to arginine. Consumption of citrulline may increase plasma nitric oxide levels promoting increase in blood flow, glucose uptake and oxygen delivery to the muscles thereby leading to increased strength and endurance and reduction in muscle fatigue.

Consumption of alanine may reduce muscle fatigue leading to more intense and longer periods of physical exercise. Beta-alanine may also be involved in the synthesis of carnosine which, in turn, is a precursor for generating nitric oxide synthase.

A branched chain amino acid is an amino acid having aliphatic side-chains with a branch (a central carbon atom bonded to three or more carbon atoms). Consumption of branched chain amino acids is associated with prolonged mental and physical stamina as well as a decrease in exercise-induced muscle breakdown and inflammation. The first and second nutritional supplements may comprise one or more branched chain amino acids selected from the group comprising leucine, isoleucine, valine and salts thereof. In one embodiment, the first and second nutritional supplement comprise leucine, isoleucine, and valine in a 2:1:1 ratio.

The first nutritional supplement may comprise one or more amino acids selected from the group comprising: ornithine, taurine, creatine or their salts. Consumption of ornithine has been associated with an anti-fatigue effect by increasing the efficiency of energy consumption and promoting the excretion of ammonia. Consumption of taurine may assist cardiovascular function and development and function of skeletal muscle, the retina and the central nervous system. It may also behave as an anti-oxidant, preventing oxidative stress induced by exercise.

Consumption of creatine may assist the supply of energy to muscle cells used for muscular contraction and result in restored ATP levels.

### Stimulants

A stimulant is a substance which raises levels of physiological or nervous activity in the body. The first nutritional supplement may comprise one or more stimulants from the group comprising: caffeine, ephedrine and synephrine.

Ephedrine acts synergistically with caffeine. Ephedrine may be able to induce fat loss by increasing the amount of fat available for fuel as well as by increasing heat expenditure. Some researchers attribute ephedrine with the ability to increase the metabolic rate by up to 5% in humans. Ephedrine also interacts with muscle cells, increasing heat expenditure in them as well as breaking down fat cells. It can also prevent the breakdown of muscle tissue to a small degree. Typically the amount of ephedrine in the first nutritional supplement may be 20-50 mg.

Synephrine may increase both energy and metabolic rate without increasing heart rate or blood pressure. Synephrine is thought to target the adrenergic receptors in the brain which are related to reduced appetite, high metabolism, cholesterol metabolism and fat burning. Therefore, synephrine may also increase lipolysis and have fat burning effects. The second nutritional supplement may comprise synephrine.

### Vitamins and Minerals

A vitamin is an organic compound which has been shown to be essential for normal growth and nutrition and is required in small quantities in the diet because they cannot be synthesized by the body.

A mineral is any of the inorganic elements, such as calcium, iron, magnesium, potassium or sodium that are essential to the functioning of the human body and are required in small quantities in the diet because they cannot be synthesized by the body.

The first, second and third nutritional supplements may comprise one or more vitamins selected from the group comprising: vitamin A (retinol), vitamin D (cholecalciferol), vitamin E group (a-tocopherol and menaquinones), thiamine (vitamin B1), riboflavin (vitamin B2), niacin, vitamin B6 group, folic acid, vitamin B12 (cobalamins), biotin, choline, pantothenic acid, vitamin C (ascorbic acid), vitamin K group, and mixtures thereof. The amount of vitamin or vitamins present in the first nutritional and second nutritional supplements is dependent on the particular vitamin and is generally the recommended daily allowance for that vitamin.

Vitamin B12 is involved in several metabolic processes in the human body, in particular DNA synthesis and regulation, fatty acid synthesis and energy production

The first, second and third nutritional supplements may comprise one or more minerals selected from the group comprising: calcium, magnesium, phosphorus, iron, zinc, iodine, selenium, potassium, copper, manganese, molybdenum and salts thereof. Mineral salts refers to organic and inorganic salts of these minerals and include but are to limited to gluconate, acetate, chloride an disulfate salts. The amount of mineral or minerals present in the first nutritional second and third nutritional supplements is dependent on the particular mineral and is generally the recommended daily allowance for that mineral. Advantageously, consumption of minerals, in particular the salts thereof may supplement or replenish the body's electrolytes.

In one embodiment, the first, second and third nutritional supplements may comprise the following minerals:

| Ingredient | Per Serving | | Per Pound | |
|---|---|---|---|---|
| Salt (min) | 11,000 | mg | 50% | |
| Salt (max) | | | 51% | |
| Chloride (Min) | 10,300 | mg | 47% | |
| Sodium (min) | 4,400 | mg | 20% | |
| Sodium (max) | | | 24% | |
| Potassium (Min) | 3,886 | mg | 18% | |
| Calcium (min) | 342 | mg | 2% | |
| Calcium (max) | | | 2.1% | |
| Magnesium | 245 | mg | 1% | |
| Vitamin D3 | 500 | IU | 10,045 | IU |
| Zinc | 7 | mg | 318 | ppm |
| Manganese | 7 | mg | 318 | ppm |
| Copper | 6 | mg | 273 | ppm |

### Botanicals

The term ‘botanical’ as used herein refers to a substance derived from a plant source, that is, from roots, leaves, bark or berries of plants, and used in the human diet. The first, second and third nutritional supplements may comprise one or more botanicals selected from a group comprising cayenne, echinacea, Siberian ginseng panax ginseng, guarana, ginko biloba, kola nut, goldenseal, golo kola, schizandr, elderberry, St. Johns Wort, valerian and ephedra, B-sitosterol from wheat germ or corn oil, cafestol from green tea, D-limonene from citrus frutis, kabweol from green tea, nomilin from citrus fruits, oltipraz from cruciferous vegetables, sulphoraphne from broccoli, bio-perine from black pepper fruit, yohimbine derived from the bark of the pausinystalia yohimbe tree, hesperidin (flavanone glycoside found in citrus fruits), naringin (favanone glycoside found in citrus fruits), forskolin (a labdane diterpene that is produced by the Indian Coleus plant) and tangeretin from tangerines, extracts from black tea, folic acid, garlic oil, green tea extract, lemon oil, mace licorice, menthol, onion oil, orange oil, rosemary extract, and milk thistle extract.

In some embodiments the first, second and third nutritional supplements may comprise one or more botanicals from the group comprising: green tea extract, bioperine, cayenne, raspberry ketones, forskolin, yohimbine, herpseridin and naringin.

Consumption of green tea extract is thought to stimulate fat oxidation and to enhance the resting metabolism.

Bioperine has an effect on absorption of nutrients, in particular vitamin C, selenium, beta-carotene, vitamin A, vitamin B6 and coenzymeQ from the intestine and is thought to improve bioenhancement.

Cayenne stimulates digestion and muscle movement in the intestines, which helps restore deficient digestive secretions and aids absorption of food nutrients. Cayenne also stimulates circulation and blood flow to the peripheral areas of the body.

Raspberry ketones is thought to have similar effects to cayenne and synephrine.

Forskolin (Coleus Forskohlii) stimulates the production of cyclic AMP (cAMP), which helps cells communicate with each other. As the level of cAMP increases, it signals the body to increase the amount of the enzyme Hormone-Sensitive Lipase (HSL) and potentially helps to stimulate the release of thyroid hormones.

In one embodiment, the first nutritional supplement comprises creatine monohydrate, one or more branched chain amino acids, one or more non-essential α-amino acids, β-alanine, betaine (trimethyl glycine), α-glycerylphosphorylcholine, caffeine, vitamin B12 (methylcobalamin), bioperine, DMAE (2-dimethylaminoethanol), cayenne.

In an alternative embodiment, the first nutritional supplement comprises creatine, one or more branched chain amino acids, one or more non-essential α-amino acids, tryptophan, lysine, ornithine and taurine.

Preferred non-essential α-amino acids include, but are not limited to, citrulline, glutamine, aspartic acid, arginine, tyrosine or the salts thereof.

For example, in one particular embodiment, the first nutritional supplement may comprise creatine monohydrate in an amount of 2 to 10 grams; citrulline malate in an amount of from 2 to 10 grams; β-alanine in an amount of 1 to 5 grams, branched chain amino acids (BCAA) in an amount of 4 to 12 grams with a ratio of leucine:isoleucine:valine varying in a range of from 2:1:1 to 10:1:1; betaine anhydrous in an amount of 100 mg to 3 grams; α-glycerylphosphorylcholine in an amount of 150 to 200 mg; caffeine in an amount of 100-500 mg; ephedrine in an amount of 20 to 50 mg; vitamin B12 in an amount of 100 to 500 mg; bioperine in an amount of 1 to 10 mg; 2-dimethylaminoethanol in an amount of 10 to 100 mg; and cayenne in an amount of 100 to 500 mg.

In another specific embodiment, the first nutritional supplement may comprise creatine monohydrate in an amount of 3 to 10 grams; citrulline malate in an amount of from 1 to 10 grams; tryptophan in an amount of 2 to 6 grams; lysine in an amount of 1 to 3 grams; ornithine in an amount of 1 to 10 grams; taurine in an amount of 500 to 2000 mg; and branched chain amino acids in an amount of in an amount of 4 to 12 grams with a ratio of leucine:isoleucine:valine varying in a range of from 2:1:1 to 10:1:1.

In one embodiment, the second nutritional supplement comprises electrolytes, including but not limited to, sodium chloride, potassium chloride, calcium carbonate, magnesium amino acid chelate, zinc citrate, copper gluconate, manages amino acid chelate, Vitamin D3 supplement; one or more branched chain amino acids, one or more essential amino acids, acetyl L-carnitine, yohimbine/yohimbe, synephrine, capsaicin, green tea extract, pyrroloquioline quinone, raspberry ketones, hesperidin and/or naringin, and forskolin, The electrolyte, one or more branched chain amino acids and one or more essential amino acids may be provided as a pre-prepared formulation referred to as an ‘electrolyte/BCAA/EAA complex’.

In one particular embodiment, the second nutritional supplement comprises the electrolyte/BCAA/EAA complex in an amount of 4 to 8 g; acetyl L-carnitine in an amount of 1-4 g; yohimbine/yohimbe in an amount of 5 to 20 mg; synephrine in an amount of 0.1-0.3 mg/kg; capsaicin in an amount of 3 to 15 mg; green tea extract in an amount of 50-250 mg; pyrroloquioline quinone in an amount of 10 to 60 mg; raspberry ketones in an amount of 100 to 400 mg; herperidin or naringin in an amount of 100 to 1000 mg; and forskolin in an amount of 25 to 250 mg.

In one particular embodiment, the third nutritional supplement comprises sodium citrate or sodium chloride in an amount of 100 to 500 mg; potassium phosphate (mono) in an amount of 10 to 100 mg; magnesium lactate in an amount of 1 to 10 mg; green tea extract in an amount of 150-250 mg; sucrose, glucose, citric acid, silicon dioxide.

### Sequentially Delivering Nutritional Supplements

The present disclosure also provides a method of sequentially delivering nutritional supplements respectively formulated to be consumed before, during and/or after physical exercise.

Said method comprises:

providing a confectionery product comprising:
a) a hard candy outer portion comprising a first nutritional supplement formulated for consumption before physical exercise; and
b) a core of chewy candy encapsulated in the hard candy outer portion, said core comprising a second nutritional supplement formulated for consumption during and/or after physical exercise;
   wherein the first nutritional supplement is consumed by keeping said confectionery product in the oral cavity for a period of time sufficient to dissolve the hard candy outer portion, thereby liberating said core, and
   the second nutritional supplement is subsequently consumed by masticating said liberated core in the oral cavity for a period of time sufficient to consume the second nutritional supplement.

In one embodiment, the hard candy outer portion 12 may be consumed prior to undertaking physical exercise, for example thirty minutes before commencing physical exercise.

The core 14 of chewy candy is liberated from the hard candy outer portion 12 by consumption of the hard candy outer portion 12. The second nutritional supplement may be consumed by chewing the liberated core 14 during and/or after physical exercise.

In an alternative embodiment, the confectionery product 10′ includes the edible stick 16 having a first end 18 extending into the core 14 of chewy candy. The edible stick 16 may be liberated after consuming the hard candy outer portion 12 and the core 14 of chewy candy. The third nutritional supplement may be consumed after undertaking physical exercise.

### Method of Preparing The Confectionery Product

A method of preparing a confectionery product for consumption before, during and/or after physical exercise is disclosed.

Said method comprises:
providing a molten hard candy precursor comprising a first nutritional supplement formulated for consumption before physical exercise
forming a core of chewy candy comprising a second nutritional supplement formulated for consumption during and/or after physical exercise, and
encapsulating said core in said molten hard candy precursor and cooling said molten hard candy precursor to produce a hard candy outer portion.

In an alternative embodiment, said method further comprises the step of encapsulating a first end of an edible stick comprising a third nutritional supplement in the core of chewy candy prior to encapsulating said core in said molten hard candy precursor.

The hard candy confectionery, the chewy candy core and the edible stick may be manufactured by any convenient method well known to one of ordinary skill in the art of making confectionery.

For the hard candy outer portion, a slurry of water, sugar and syrup, together with colouring agents, flavouring agents, acidulants and so forth may be prepared and heated to 160° C. to remove moisture and produce a molten hard candy mixture. In one embodiment, the slurry may comprise about 45% to 70% by weight sugar, about 30 to 55% corn syrup, and up to 5% colouring agents, flavouring agents, acidulants and so forth. The first nutritional supplement may be mixed with and dispersed in the molten hard candy mixture before it hardens at a temperature less than 160° C. The hard candy outer portion may contain from about 10% to about 90% first nutritional supplement by weight of the hard candy outer portion. It will be appreciated that the first nutritional supplement is mixed with and dispersed into the molten hard candy mixture as a dry powder.

For the core of chewy candy, a slurry of water, sugar and syrup together with colouring agents, flavouring agents, acidulants and so forth may be heated to 128° C. to reduce moisture and produce a molten chewy candy mixture. The second nutritional supplement is then mixed with and dispersed in the molten chewy candy mixture. The core 14 may contain from about 10% to about 90% second nutritional supplement by weight of the core 14. A frappe may be added to said molten mixture. The molten mixture is then aerated before being cast into a shape by pouring said molten mixture into a mold of the desired shape. It will be appreciated that the second nutritional supplement is mixed with and dispersed into the molten chewy candy mixture as a dry powder.

The core 14 of chewy candy may be formed into various shapes including, but not limited to, disc-like, spherical, oval cylindrical, conical and other solid forms.

The core 14 of chewy candy may be encapsulated in the molten hard candy mixture by inserting said core 14 in a mold and pouring the molten hard candy mixture into the mold.

The hard candy outer portion 12 may be formed into various shapes, including but not limited to disc-like, spherical, cylindrical, conical and other solid forms. The shape of the hard candy outer portion 12 may be informed by the shape of the core 14. For example, the hard candy outer portion 12 may be a regular thickness of from 3 to 10 mm around the core 14. Alternatively, the hard candy outer portion 12 may be poured into a mold of the desired shape into which the core 14 has been inserted.

The confectionery product 10 may be provided with a non-edible stick inserted into the molten hard candy outer portion 12 and the core 14, to give the appearance of a lollipop. It will be appreciated that when the core 14 is liberated from the hard candy outer portion 12 after consumption of the hard candy outer portion 12, the core 14 may be readily removed from the stick and chewed over a period of time until consumed.

Alternatively, the confectionery product 10′ may be provided with an edible stick 16 initially inserted into the core 14 and then encapsulated, together with the core 14, in the molten hard candy mixture poured into the mold, as described previously.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLE

The invention is further illustrated by the following example. The example is provided for illustrative purposes only. It is not to be construed as limiting the scope or content of the invention in any way.

Table 1 lists the active ingredients and their amounts in the first nutritional supplement in the hard candy outer portion:

TABLE 1

| | | |
|---|---|---|
| Citrulline malate | 2 | g |
| Creatine monohydrate | 2 | g |
| Beta alanine | 2.5 | g |
| Betaine (trimethyl glycine) anhydrous | 2 | g |
| Alpha GPC (glycerylphosphorylcholine) | 150 | mg |
| Caffeine | 200 | mg |
| Ephedrine | 24 | mg |
| B12 (methylcobalamin) | 500 | mg |
| Bioperine | 5 | mg |
| 2-dimethylaminoethanol (DMAE) | 50 | mg |
| cayenne | 250 | mg |

Table 2 lists the active ingredients and the amounts in the second nutritional supplement in the consumable core of chewy candy:

TABLE 2

| | | |
|---|---|---|
| Electrolyte/BCAA/EAA complex | 4 | g |
| Betaine (trimethyl glycine) anhydrous | 500 | mg |
| Acetyl L carnitine | 500 | mg |
| Yohimbine/yohimbe | 20 | mg |
| Synephrine | 0.1-0.3 | mg/kg |
| Capsaicin | 3 | mg |
| Green tea extract | 150-250 | mg |
| Pyrroloquioline quinone | 20-60 | mg |
| Raspberry ketones | 200-400 | mg |
| Hesperidin or naringin | 500-1000 | mg |
| Forskolin | 250 | mg |

1. A confectionery product for consumption before, during and/or after physical exercise comprising:
a) a hard candy outer portion comprising a first nutritional supplement formulated for consumption before physical exercise; and
b) a core of chewy candy encapsulated in the hard candy outer portion, said core comprising a second nutritional supplement formulated for consumption during and/or after physical exercise, wherein, in use, the hard candy outer portion is consumed before said core so as to sequentially deliver the first and second nutritional supplements to the consumer.

2. The confectionery product of claim I further comprising an edible stick having a first end extending into the core of chewy candy, said edible stick comprising a third nutritional supplement formulated for consumption after physical exercise.

3. A method of sequentially delivering nutritional supplements respectively formulated to be consumed before, during and/or after physical exercise, wherein said method comprises:
providing a confectionery product comprising:
a) a hard candy outer portion comprising a first nutritional supplement formulated for consumption before physical exercise; and
b) a core of chewy candy encapsulated in the hard candy outer portion, said core comprising a second nutritional supplement formulated for consumption during and/or after physical exercise;
wherein the first nutritional supplement is consumed by keeping said confectionery product in the oral cavity for a period of time sufficient to dissolve the hard candy outer portion, thereby liberating said core, and
the second nutritional supplement is subsequently consumed by masticating said liberated core in the oral cavity for a period of time sufficient to consume the second nutritional supplement.

4. The method of claim 3, wherein the confectionery product further comprises an edible stick having a first end extending into the core of chewy candy, said edible stick comprising a third nutritional supplement formulated for consumption after physical exercise.

5. The method of claim 3, wherein the hard candy outer portion is consumed prior to undertaking physical exercise and said liberated core may be subsequently consumed during and/or after undertaking physical exercise.

6. The method of claim 4, wherein the edible stick is consumed after undertaking physical exercise.

7. A method of preparing a confectionery product for consumption before, during and/or after physical exercise, wherein said method comprises:
providing a molten hard candy precursor comprising a first nutritional supplement formulated for consumption before physical exercise
forming a core of chewy candy comprising a second nutritional supplement formulated for consumption during and; or after physical exercise, and
encapsulating said core in said molten hard candy precursor and cooling said molten hard candy precursor to produce a hard candy outer portion.

8. The method of claim 7 further comprising:
forming an edible stick comprising a third nutritional supplement formulated for consumption after physical exercise and inserting the edible stick into the core of chewy candy prior to encapsulating said core in said molten hard candy precursor.

9. The confectionery product of claim 1, wherein the first nutritional supplement comprises one or more substances selected from the group consisting of amino acids such as essential amino acids, non-essential amino acids and branched chain amino acids, and salts thereof; stimulants; vitamins; minerals; botanicals; creatine and salts thereof; dimethylaminoethanol and salts thereof; and choline compounds such as L-alpha glycerylphosphorylcholine.

10. The confectionery product of claim 1, wherein the second nutritional supplement comprises one or more substances selected from the group consisting of amino acids such as essential amino acids, non-essential amino acids and branched chain amino acids, and salts thereof; vitamins; minerals, in particular electrolytes; botanicals; acetyl L-carnitine, acetyl N-carnitine and salts thereof; and pyrroloquioline quinone and salts thereof.

11. The confectionery product of claim 1, wherein the second nutritional supplement comprises leucine, isoleucine and valine in a ratio of 2:1:1.

12. The confectionery product of claim 1, wherein the first nutritional supplement comprises creatine monohydrate in an amount of 2 to 10 grams; citrulline malate in an amount of from a to 10 grams; β-alanine in an amount of 1 to 5 grams, branched chain amino acids (BCAA) in an amount of 4 to 12 grams; betaine anhydrous in an amount of 100 mg to 3 grams; α-glycerylphosphorylcholine in an amount of 150 to 200 mg; caffeine in an amount of 100-500 mg; ephedrine in an amount of 20 to 50 mg; vitamin B12 lay an amount of 100 to 500 mg; bioperine in an amount of 1 to 10 mg; 2-dimethylaminoethanol in an amount of 10 to 100 mg; and cayenne in an amount of 100 to 500 mg.

13. The confectionery product of claim 1, wherein the first nutritional supplement comprises creatine monohydrate in an amount of 3 to 10 grams; citrulline malate in an amount of from 1 to 10 grams; tryptophan in an amount of 2 to 6 grams; lysine in an amount of 1 to 3 grams; ornithine in an amount of 0.1 to /0 grams; taurine in an amount of 500 to 2000 mg; and branched chain amino acids in an amount of 4 to 12 grams.

14. The confectionery product of claim 1, wherein the second nutritional supplement comprises the electrolyte/BCAA/EAA complex in an amount of 4 to 8 g; acetyl L-carnitine in an amount of 1-4 g; yohimbine/yohimbe in an amount of 5 to 20 mg; synephrine in an amount of 0.1-0.3 mg/kg; capsaicin in an amount of 3 to 15 mg; green tea extract in an amount of 50-250 mg; pyrroloquioline quinone in an amount of 20 to 60 mg; raspberry ketones in an amount of 100 to 400 mg; herperidin or naringin in an amount of 100 to 1000 mg; and forskolin in an amount of 25 to 250 mg.

15. The confectionery product of claim 2, wherein the third nutritional supplement comprises one or more substances selected from the group consisting of a carbohydrate such as a sugar; a vitamin; a mineral, in particular electrolytes; and a botanical.

16. The confectionery product of claim 2, wherein the third nutritional supplement comprises sodium citrate or sodium chloride in an amount of 100 to 500 mg; potassium phosphate (mono) in an amount of 10 to 100 mg; magnesium lactate in an amount of 1 to 10 mg; green tea extract in an amount of 150-250 mg; sucrose, glucose, citric acid, silicon dioxide.

17. The method of claim 3, wherein the first nutritional supplement comprises one or more substances selected from the group consisting of amino acids such as essential amino acids, non-essential amino acids and branched chain amino acids, and salts thereof; stimulants; vitamins; minerals; botanicals; creatine and salts thereof; dimethylaminoethanol and salts thereof; and choline compounds such as L-alpha glycerylphosphorylcholine.

18. The method of claim 7, wherein the first nutritional supplement comprises one or more substances selected from the group consisting of amino acids such as essential amino acids, nonessential amino acids and branched chain amino acids, and salts thereof; stimulants; vitamins; minerals; botanicals; creatine and salts thereof; dimethylaminoethanol and salts thereof; and choline compounds such as L-alpha glycerylphosphorylcholine.

19. The method of claim 3, wherein the second nutritional supplement comprises one or more substances selected from the group consisting of amino acids such as essential amino acids, nonessential amino acids and branched chain amino acids, and salts thereof; vitamins; minerals, in particular electrolytes; botanicals; acetyl L-carnitine, acetyl N-carnitine and salts thereof; and pyrroloquioline quinone and salts thereof.

20. The method of claim 7, wherein the second nutritional supplement comprises one or more substances selected from the group consisting of amino acids such as essential amino acids, non-essential amino acids and branched chain amino acids, and salts thereof; vitamins; minerals, in particular electrolytes; botanicals; acetyl L-carnitine, acetyl N-carnitine and salts thereof; and pyrroloquioline quinone and salts thereof.

21. The method of claim 3, wherein the second nutritional supplement comprises leucine, isoleucine and valine in a ratio of 2:1:1.

22. The method of claim 7, wherein the second nutritional supplement comprises leucine, isoleucine and valine in a ratio of 2:1:1.

23. The method of claim 3, wherein the first nutritional supplement comprises creatine monohydrate in an amount of 2 to 10 grams; citrulline malate in an amount of from a to 10 grams; β-alanine in an amount of 1 to 5 grams, branched chain amino acids (BCAA) in an amount of 4 to 12 grams; betaine anhydrous in an amount of 100 mg to 3 grams; α-glycerylphosphorylcholine in an amount of 150 to 200 mg; caffeine in an amount of 100-500 mg; ephedrine in an amount of 20 to 50 mg; vitamin B12 in an amount of 100 to 500 mg; bioperine in an amount of 1 to 10 mg; 2-dimethylaminoethanol in an amount of 10 to 100 mg; and cayenne in an amount of 100 to 500 mg

24. The method of claim 7, wherein the first nutritional supplement comprises creatine monohydrate in an amount of 2 to 10 grams; citrulline malate in an amount of from a to 10 grams; β-alanine in an amount of 1 to 5 grams, branched chain amino acids (BCAA) in an amount of 4 to 12 grams; betaine anhydrous in an amount of 100 mg to 3 grams; α-glycerylphosphorylcholine in an amount of 150 to 200 mg; caffeine in an amount of 100-500 mg; ephedrine in an amount of 20 to 50 mg; vitamin B12 in an amount of 100 to 500 mg; bioperine in an amount of 1 to 10 mg; 2-dimethylaminoethanol in an amount of 10 to 100 mg; and cayenne in an amount of 100 to 500 mg

25. The method of claim 3, wherein the first nutritional supplement comprises creatine monohydrate in an amount of 3 to 10 grams; citrulline malate in an amount of from 1 to 10 grams; tryptophan in an amount of 2 to 6 grams; lysine in an amount of 1 to 3 grams; ornithine in an amount of 0.1 to 10 grams; taurine in an amount of 500 to 2000 mg; and branched chain amino acids in an amount of 4 to 12 grams.

26. The method of claim 7, wherein the first nutritional supplement comprises creatine monohydrate in an amount of 3 to 10 grams; citrulline malate in an amount of from 1 to 10 grams; tryptophan in an amount of 2 to 6 grams; lysine in an amount of 1 to 3 grams; ornithine in an amount of 0.1 to 10 grams; taurine in an amount of 500 to 2000 mg; and branched chain amino acids in an amount of 4 to 12 grams.

27. The method of claim 3, wherein the second nutritional supplement comprises the electrolyte/BCAA/EAA complex in an amount of 4 to 8 g; acetyl L-carnitine in an amount of 1-4 g; yohimbine/yohimbe in an amount of 5 to 20 mg; synephrine in an amount of 0.1-0.3 mg/kg; capsaicin in an amount of 3 to 15 mg; green tea extract in an amount of 50-250 mg; pyrroloquioline quinone in an amount of 20 to 60 mg; raspberry ketones in an amount of 100 to 400 mg; herperidin or naringin in an amount of 100 to 1000 mg; and forskolin in an amount of 25 to 250 mg.

28. The method of claim 7, wherein the second nutritional supplement comprises the electrolyte/BCAA/EAA complex in an amount of 4 to 8 g; acetyl L-carnitine in an amount of 1-4 g; yohimbine/yohimbe in an amount of 5 to 20 mg; synephrine in an amount of 0.1-0.3 mg/kg; capsaicin in an amount of 3 to 15 mg; green tea extract in an amount of 50-250 mg; pyrroloquioline quinone in an amount of 20 to 60 mg; raspberry ketones in an amount of 100 to 400 mg; herperidin or naringin in an amount of 100 to 1000 mg; and forskolin in an amount of 25 to 250 mg.

29. The method of claim 4, wherein the third nutritional supplement comprises one or more substances selected from the group consisting of a carbohydrate such as a sugar; a vitamin; a mineral, in particular electrolytes; and a botanical.

30. The method of claim 8, wherein the third nutritional supplement comprises one or more substances selected from the group consisting of a carbohydrate such as a sugar; a vitamin; a mineral, in particular electrolytes; and a botanical.

31. The method of claim 4, wherein the third nutritional supplement comprises sodium citrate or sodium chloride in an amount of 100 to 500 mg; potassium phosphate (mono) in an amount of 10 to 100 mg; magnesium lactate in an amount of I to 10 mg; green tea extract in an amount of 150-250 mg; sucrose, glucose, citric acid, silicon dioxide.

32. The method of claim 8, wherein the third nutritional supplement comprises sodium citrate or sodium chloride in an amount of 100 to 500 mg; potassium phosphate (mono) in an amount of 10 to 100 mg; magnesium lactate in an amount of 1 to 10 mg; green tea extract in an amount of 150-250 mg; sucrose, glucose, citric acid, silicon dioxide.
